(19) United States
(12) Patent Application Publication
(10) Pub. No.: US 2022/0181694 A1
(43) Pub. Date: Jun. 9, 2022

(54) ELECTROLYTE SOLUTION-CONTAINING LIQUID COMPOSITION, METHOD OF PRODUCING ELECTROLYTE SOLUTION-CONTAINING LIQUID COMPOSITION, AND METHOD OF RESTORING CAPACITY OF NON-AQUEOUS ELECTROLYTE SECONDARY BATTERY

(71) Applicant: TOYOTA JIDOSHA KABUSHIKI KAISHA, Toyota-shi (JP)

(72) Inventors: Katsuhiko NAGAYA, Toyota-shi (JP); Shinobu OKAYAMA, Miyoshi-shi (JP); Nobuhiro OGIHARA, Nagakute-shi (JP); Yasuhito KONDO, Nagakute-shi (JP); Tsuyoshi SASAKI, Nagakute-shi (JP)

(73) Assignee: TOYOTA JIDOSHA KABUSHIKI KAISHA, Toyota-shi (JP)

(21) Appl. No.: 17/457,336

(22) Filed: Dec. 2, 2021

(30) Foreign Application Priority Data
Dec. 4, 2020 (JP) 2020-201789

(51) Int. Cl. H01M 10/0568; H01M 10/0569

(52) U.S. Cl. CPC H01M 10/0568; H01M 2300/0028; H01M 10/0569

(57) ABSTRACT

A main object of the present disclosure is to provide a composition capable of conveniently feeding carrier ions which contribute to charge and discharge. The present disclosure achieves the object by providing an electrolyte solution-containing liquid composition for use to feed carrier ions to a non-aqueous electrolyte secondary battery, the electrolyte solution-containing liquid composition comprises a liquid composition including a solvent and a dissolved substance; and an electrolyte solution, a content of the electrolyte solution in the electrolyte solution-containing liquid composition is 30% by volume or more and 50% by volume or less, the solvent includes 1,2-dimethoxyethane, the dissolved substance includes an ionic compound, the ionic compound is composed of a radical anion of an aromatic compound and a metal cation, the aromatic compound is polyacene or polyphenyl, and the metal cation being an ion of the same type as the carrier ions.

### TECHNICAL FIELD

The present disclosure relates to an electrolyte solution-containing liquid composition, a method of producing an electrolyte solution-containing liquid composition, and method of restoring capacity of a non-aqueous electrolyte secondary battery. Incidentally, in the present specification, “a non-aqueous electrolyte secondary battery” may be simply called “a battery”.

### BACKGROUND ART

In a non-aqueous electrolyte secondary battery, it is typical that carrier ions travel between a cathode (positive electrode) and an anode (negative electrode), and thereby charge and discharge occur. For example, Patent Literature 1 discloses to use a mixed solvent including ethylene carbonate, and 1,2-dimethoxyethane for a non-aqueous electrolyte solution of a non-aqueous electrolyte secondary battery. Also, Patent Literature 2 discloses to use a mixed solvent including ethylene carbonate, 1,2-dimethoxyethane, and propylene carbonate for a non-aqueous electrolyte solution of a non-aqueous electrolyte secondary battery. Further, Patent Literature 3 discloses a third electrode for feeding lithium ions to a cathode.

In a non-aqueous electrolyte secondary battery, the electrolyte solution may be reduced and degraded during use, and a film may be formed on a surface of the electrode. When a part of carrier ions are trapped into this film, the amount of carrier ions, which contribute to charge and discharge, is decreased so as to be a cause of a decrease in the capacity of the non-aqueous electrolyte secondary battery. In order to restore the capacity of a lithium ion secondary battery, Patent Literature 3 discloses to provide a third electrode for feeding carrier ions, in addition to a cathode and an anode, externally short-circuit the third electrode with the cathode to allow carrier ions (lithium ions) to move from the third electrode to the cathode, and to supply carrier ions only to the cathode. However, since the third electrode is provided in Patent Literature 3, the battery structure may be complicated. Further, changing connection between the electrodes may also be complicated, and from the viewpoint of easy and simple operation, there may be room for improvement.

### CITATION LIST

### Patent Literatures

Patent Literature 1: Japanese Patent Application Laid-Open (JP-A) No. H06-052888
Patent Literature 2: JP-A H06-176793
Patent Literature 3: JP-A 2016-076358

### SUMMARY OF DISCLOSURE

### Technical Problem

The present disclosure has been made in view of the above circumstances, and a main object thereof is to provide a composition capable of conveniently feeding carrier ions which contribute to charge and discharge.

### Solution to Problem

In order to achieve the object, the present disclosure provides an electrolyte solution-containing liquid composition for use to feed carrier ions to a non-aqueous electrolyte secondary battery, the electrolyte solution-containing liquid composition comprises a liquid composition including a solvent and a dissolved substance; and an electrolyte solution, a content of the electrolyte solution in the electrolyte solution-containing liquid composition is 30% by volume or more and 50% by volume or less, the solvent includes 1,2-dimethoxyethane, the dissolved substance includes an ionic compound, the ionic compound is composed of a radical anion of an aromatic compound and a metal cation, the aromatic compound is polyacene or polyphenyl, and the metal cation being an ion of the same type as the carrier ions.

According to the present disclosure, since a predetermined solvent and a predetermined amount of the electrolyte solution are included, the electrolyte solution-containing liquid composition is capable of conveniently feeding carrier ions, which contribute to charge and discharge, to a non-aqueous electrolyte secondary battery.

In the disclosure, the radical anion may include at least one type selected from the group consisting of a naphthalene radical anion and a biphenyl radical anion, and the metal cation may include lithium ions.

The present disclosure also provides a method of producing an electrolyte solution-containing liquid composition for use to feed carrier ions to a non-aqueous electrolyte secondary battery, the method comprises: a precursor solution preparing step of preparing a precursor solution by dissolving an aromatic compound into a solvent; a liquid composition preparing step of preparing a liquid composition by dissolving a metal into the precursor solution; and an electrolyte solution-containing liquid composition preparing step of preparing an electrolyte solution-containing liquid composition by mixing the liquid composition and an electrolyte solution so as a content of the electrolyte solution in the electrolyte solution-containing liquid composition is 30% by volume or more and 50% by volume or less, and the solvent includes 1,2-dimethoxyethane, the aromatic compound is polyacene or polyphenyl, and a metal cation resulting from the metal being an ion of the same type as the carrier ions.

According to the present disclosure, an electrolyte solution-containing liquid composition capable of conveniently feeding carrier ions, which contribute to charge and discharge, to a non-aqueous electrolyte secondary battery may be produced.

The present disclosure also provides a method of restoring capacity of a non-aqueous electrolyte secondary battery, the method comprises: an electrolyte solution-containing liquid composition preparing step of preparing the electrolyte solution-containing liquid composition described above; and a mixing step of mixing the electrolyte solution-containing liquid composition with an electrolyte solution of the non-aqueous electrolyte secondary battery having an observed battery capacity loss from a predetermined capacity.

According to the present disclosure, by using the electrolyte solution-containing liquid composition described above, carrier ions, which contribute to charge and discharge, may be conveniently fed to a non-aqueous electrolyte secondary battery, so that the capacity of the non-aqueous electrolyte secondary battery may be restored.

In the disclosure, the method may not include a constant current-constant voltage charging step of performing constant current-constant voltage charging to the non-aqueous electrolyte secondary battery, after the electrolyte solution-containing liquid composition is mixed with the electrolyte solution of the non-aqueous electrolyte secondary battery.

### Advantageous Effects of Disclosure

The electrolyte solution-containing liquid composition in the present disclosure exhibits an effect that carrier ions, which contribute to charge and discharge, may be conveniently fed.

### BRIEF DESCRIPTION OF DRAWING

FIGS. 1A and 1B are photographs of an electrolyte solution-containing liquid composition and an electrode of a battery in Example 1.

FIGS. 2A and 2B are photographs of an electrolyte solution-containing liquid composition and an electrode of a battery in Comparative Example 2.

FIG. 3 is a schematic flowchart of a method of producing an electrolyte solution-containing liquid composition in the present disclosure.

FIG. 4 is a schematic flowchart of a method of restoring capacity of a non-aqueous electrolyte secondary battery in the present disclosure.

FIG. 5 is a schematic flowchart of a conventional method of restoring capacity of a non-aqueous electrolyte secondary battery.

FIG. 6 is a graph illustrating the results of a cycle resistance test.

### DESCRIPTION OF EMBODIMENTS

An electrolyte solution-containing liquid composition, a method of producing an electrolyte solution-containing liquid composition, and method of restoring capacity of a non-aqueous electrolyte secondary battery in the present disclosure will be hereinafter described in detail.

A. Electrolyte Solution-Containing Liquid Composition

The electrolyte solution-containing liquid composition in the present disclosure is characterized by being used to feed carrier ions to a non-aqueous electrolyte secondary battery, the electrolyte solution-containing liquid composition comprises a liquid composition including a solvent and a dissolved substance; and an electrolyte solution, a content of the electrolyte solution in the electrolyte solution-containing liquid composition is 30% by volume or more and 50% by volume or less, the solvent includes 1,2-dimethoxyethane, the dissolved substance includes an ionic compound, the ionic compound is composed of a radical anion of an aromatic compound and a metal cation, the aromatic compound is polyacene or polyphenyl, and the metal cation being an ion of the same type as the carrier ions.

According to the present disclosure, since a predetermined solvent and a predetermined amount of the electrolyte solution are included, the electrolyte solution-containing liquid composition is capable of conveniently feeding carrier ions, which contribute to charge and discharge, to a non-aqueous electrolyte secondary battery.

As described above, in a non-aqueous electrolyte secondary battery, carrier ions which contribute to charge and discharge decreases during use, and the battery capacity tends to decrease gradually. If the decreased carrier ions can be fed, the life-span of a battery may be elongated. As the result of extensive investigation about feeding carrier ions by a convenient method, it has been found out that the battery capacity may be restored by introducing a liquid composition including a predetermined ionic compound to a battery having an observed battery capacity loss, and by performing constant current-constant voltage charging to the battery after the introduction, a decrease in battery capacity due to charge-discharge cycle during use thereafter may be suppressed, in other words, cycle resistance, a property wherein capacity decrease due to the charge-discharge cycle is not likely occur, may be improved.

As the result of further investigation by the present inventors, it has been found out that the battery capacity may be restored by introducing an electrolyte solution-containing liquid composition including 1,2-dimethoxyethane (DME) as a solvent of the liquid composition, and further including a predetermined amount of an electrolyte solution, into a battery having an observed battery capacity loss; also, the cycle resistance may be improved even though a constant current-constant voltage charging is not performed after the introduction. By using the electrolyte solution-containing liquid composition, the cycle resistance of a battery may be improved by “introducing only”, without performing a constant current-constant voltage charging which requires a long time. Therefore, the feeding of carrier ions to a battery may be greatly simplified so as to contribute greatly to the life-span elongation of a battery.

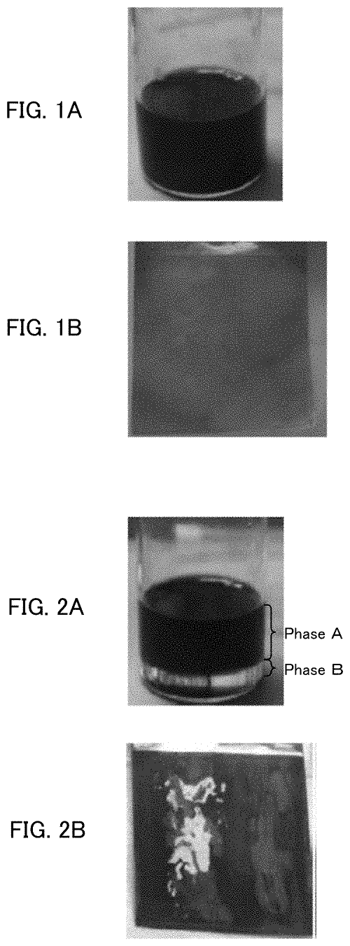

When DME was used as a solvent, the electrolyte solution was preferably mixed in the electrolyte solution-containing liquid composition (refer to FIG. 1A). Meanwhile, when tetrahydrofuran (THF) was used as a solvent, it is presumed that the electrolyte solution was not preferably mixed, since a phase separation occurred as shown in FIG. 2A. Also, the electrode of the charged battery to which respective electrolyte solution-containing liquid composition was introduced, was checked, and when the solvent was DME, almost no uneven charging was confirmed as shown in FIG. 1B. Meanwhile, when the solvent was THF, uneven charging was confirmed as shown in FIG. 2B. It is presumed that the difference in the types of the used solvent was a cause of the effects in the present disclosure described above. Incidentally, FIG. 1A described above is a photograph of the electrolyte solution-containing liquid composition in Example 1 described below, FIG. 1B is a photograph of the electrode of the battery in Example 1 in a charged state, and FIGS. 2A and 2B are similar photographs in Comparative Example 2.

The electrolyte solution-containing liquid composition in the present disclosure includes a liquid composition including a solvent and a dissolved substance; and an electrolyte solution. Each of them will be hereinafter described.

1. Liquid Composition

(1) Solvent

When the dissolved substance is in a state of dissolution in the solvent, stability of the ionic compound may be improved, for example. In the present disclosure, the solvent includes 1,2-dimethoxyethane (DME). The solvent may solely include DME, and may include a solvent other than DME. As the solvent other than DME, the solvent may include, for example, a cyclic ether, and a chain ether. Specifically, the solvent may include at least one type selected from the group consisting of tetrahydrofuran (THF), 1,3-dioxolane (DOL), 1,4-dioxane (DX), and 1,2-diethoxyethane (DEE).

The proportion of DME in the entire solvent is, for example, 50% by volume or more, may be 60% by volume or more, and may be 70% by volume or more. Meanwhile, the proportion may be, for example, 100% by volume, may be 95% by volume or less, may be 90% by volume or less, and may be 80% by volume or less.

(2) Dissolved Substance

The dissolved substance is dissolved in the solvent. The dissolved substance includes an ionic compound. The ionic compound contributes to feeding carrier ions. The dissolved substance may include one type of the ionic compound alone. The dissolved substance may include two or more types of the ionic compound.

In the present disclosure, the dissolved substance may have any concentration in the liquid composition. The concentration of the dissolved substance may be selected in accordance with, for example, a balance between the amount of dead space inside the battery and the amount of carrier ions to feed. For instance, when the concentration is too low, the volume of the liquid composition may be too large to supply a sufficient amount into the battery. For instance, when the concentration is too high, a long time may be required for the liquid composition to be incorporated with an electrolyte solution.

The concentration of the dissolved substance in the liquid solution is, for example, 0.05 mol/L or more, may be 0.10 mol/L or more and may be 0.50 mol/L or more. When the concentration of the dissolved substance is 0.05 mol/L or more, carrier ion feeding may be facilitated. Meanwhile, the concentration is, for example, 1.1 mol/L or less, and may be 1.0 mol/L or less. When the concentration of the dissolved substance is 1.1 mol/L or less, carrier ion feeding may be facilitated.

<Ionic Compound>

The ionic compound is composed of a radical anion of an aromatic compound and a metal cation. The ionic compound may be either dissociated or associated. The metal cation is an ion of the same type as the carrier ions of the battery. When the battery is a lithium-ion battery, for example, both the carrier ion and the metal cation are lithium (Li) ions. In other words, the metal cation may include a Li ion, for example. When the battery is a sodium-ion battery, for example, both the carrier ion and the metal cation are sodium (Na) ions. When the battery is a magnesium-ion battery, for example, both the carrier ion and the metal cation are magnesium (Mg) ions.

The aromatic compound is a polyacene or a polyphenyl. The polyacene has a structure that includes multiple condensed aromatic rings. In the present disclosure, each aromatic ring of the polyacene may include a heteroatom in the ring. The heteroatom may be nitrogen (N), oxygen (O), and sulfur (S), for example. Each aromatic ring of the polyacene may have a substituent on the ring. The polyphenyl has a structure that includes a plurality of phenyl groups bonded via single bonds. In the present disclosure, each aromatic ring of the polyphenyl may include a heteroatom in the ring. Each aromatic ring of the polyphenyl may have a substituent on the ring.

In the present disclosure, an ionic compound in which the aromatic compound is a polyacene is called “a first ionic compound”. An ionic compound in which the aromatic compound is a polyphenyl is called “a second ionic compound”. The dissolved substance may include at least one type selected from the group consisting of the first ionic compound and the second ionic compound.

<First Ionic Compound>

The first ionic compound is represented by the following formula (1).

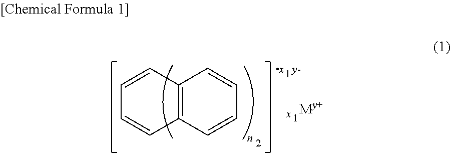

In the formula (1) above, n₁ is an integer of 1 to 4; x₁ is any numeral; M^{y+} denotes the metal cation; “y” denotes the valence of the metal cation. Each aromatic ring may include a heteroatom in the ring. Each aromatic ring may include a substituent on the ring.

The first ionic compound includes a radical anion of a polyacene. The polyacene may be an aromatic hydrocarbon. The polyacene may be naphthalene, anthracene, tetracene, and pentacene, for example. The polyacene may include a heteroatom in the ring. The polyacene may be quinoline, chromene, and acridine, for example.

The first ionic compound may be lithium naphthalenide, for example. Lithium naphthalenide is composed of a naphthalene radical anion and a Li ion.

<Second Ionic Compound>

The second ionic compound is represented by the following formula (2).

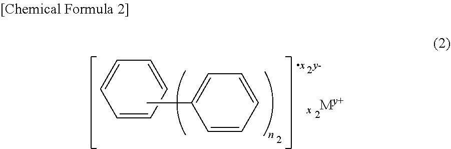

In the formula (2) above, n₂ is an integer of 1 to 4; x₂ is any numeral; M^{y+} denotes the metal cation; “y” denotes the valence of the metal cation. Each aromatic ring may include a heteroatom in the ring. Each aromatic ring may include a substituent on the ring.

The second ionic compound includes a radical anion of a polyphenyl. The polyphenyl may be a hydrocarbon. The polyphenyl may be biphenyl, o-terphenyl, m-terphenyl, p-terphenyl, p-quaterphenyl, and p-quinquephenyl, for example. The polyphenyl may include a heteroatom in the ring. The polyphenyl may be bipyridine, for example.

The second ionic compound may be lithium biphenylide, for example. The lithium biphenylide is composed of a biphenyl radical anion and a Li ion.

In the first ionic compound and the second ionic compound, examples of the substituent that may be introduced on the ring may include a halogen atom, an alkyl group, an aryl group, an alkenyl group, an alkoxy group, an aryloxy group, a sulfonyl group, an amino group, a cyano group, a carbonyl group, an acyl group, an amido group, and a hydroxy group. Each of the first ionic compound and the second ionic compound may include one type of the substituent alone. Each of the first ionic compound and the second ionic compound may include a plurality of the substituents. The “plurality” herein means at least one of “a plurality in number” and “a plurality in type”.

(3) Liquid Composition

The liquid composition in the present disclosure may further include an optional component in addition to the components described above. For example, the liquid composition may include a component capable of facilitating the dissociation of the ionic compound.

2. Electrolyte Solution

The content of the electrolyte solution in the electrolyte solution-containing liquid composition is usually 30% by volume or more, may be 33% by volume or more, and may be 35% by volume or more. The content of the electrolyte solution is usually 50% by volume or less, may be 47% by volume or less, and may be 45% by volume or less.

Any electrolyte solution may be used as long as it is a solution having electron conductivity, and an electrolyte solution used for a non-aqueous electrolyte secondary battery may be used, for example. The composition of the electrolyte solution included in the electrolyte solution-containing liquid composition may be the same as or different from the electrolyte solution used for the battery to be used together (to which carrier ions are fed).

Such an electrolyte solution may include, for example, a solvent for an aprotic electrolyte solution, and a dissolved substance for an electrolyte solution such as LiPF₆, LiBF₄, LiN(FSO₂)₂, and, LiN(CF₃SO₂)₂. Examples of the solvent for an aprotic electrolyte solution may include a cyclic carbonate such as ethylene carbonate (EC), propylene carbonate (PC), butylene carbonate (BC), vinylene carbonate (VC), vinylethylene carbonate (VEC), and fluoroethylene carbonate (FEC); and a chain carbonate such as dimethyl carbonate (DMC), ethyl methyl carbonate (EMC), and diethyl carbonate (DEC). Also, as the solvent for an aprotic electrolyte solution, only on type may be used, and two or more types may be used. The electrolyte solution may further include an additive, for example, in addition to the components described above. The additive may include a film-forming agent, and a flame retardant, for example.

3. Electrolyte Solution-Containing Liquid Composition

The electrolyte solution-containing liquid composition in the present disclosure is for use to feed carrier ions to a battery. The battery is described below in detail. Feeding carrier ions may increase or restore the capacity of the battery. The electrolyte solution-containing liquid composition may also be called “carrier-ion-feeding agent” and “capacity-restoring agent”, for example.

B. Method of Producing an Electrolyte Solution-Containing Liquid Composition

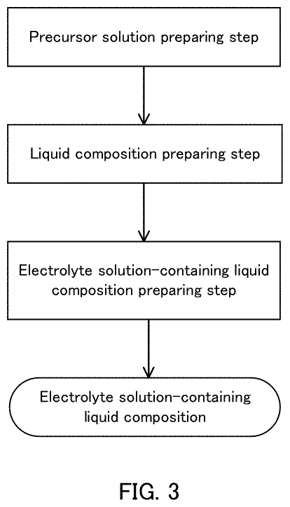

FIG. 3 is a schematic flowchart of a method of producing an electrolyte solution-containing liquid composition in the present disclosure. The method of producing an electrolyte solution-containing liquid composition in the present disclosure is a method of producing an electrolyte solution-containing liquid composition for use to feed carrier ions to a non-aqueous electrolyte secondary battery, the method comprises: a precursor solution preparing step of preparing a precursor solution by dissolving an aromatic compound into a solvent; a liquid composition preparing step of preparing a liquid composition by dissolving a metal into the precursor solution; and an electrolyte solution-containing liquid composition preparing step of preparing an electrolyte solution-containing liquid composition by mixing the liquid composition and an electrolyte solution so as a content of the electrolyte solution in the electrolyte solution-containing liquid composition is 30% by volume or more and 50% by volume or less, and the solvent includes 1,2-dimethoxyethane, the aromatic compound is polyacene or polyphenyl, and a metal cation resulting from the metal being an ion of the same type as the carrier ions.

According to the present disclosure, an electrolyte solution-containing liquid composition capable of conveniently feeding carrier ions, which contribute to charge and discharge, to a non-aqueous electrolyte secondary battery may be produced.

1. Precursor Solution Preparing Step

The precursor solution preparing step in the present disclosure is a step of preparing a precursor solution by dissolving an aromatic compound into a solvent.

The dissolving an aromatic compound may be performed, for example, in an environment with a low dew point. For example, the dissolving may be performed in an argon (Ar) atmosphere. The environment with a low dew point may be an environment with a dew point of −20° C. or less, for example. The environment with a low dew point may be an environment with a dew point of −40° C. or less, for example. The environment with a low dew point may be an environment with a dew point of −60° C. or less, for example. Also, the dissolving an aromatic compound may be performed, for example, in an environment at room temperature. In order to facilitate the dissolution of the aromatic compound, warming may be performed, for example.

The aromatic compound is a precursor of the radical anion. For example, powder of the aromatic compound may be prepared. The powder of the aromatic compound is introduced to the solvent. For achieving substantially complete dissolution of the aromatic compound, the mixture is sufficiently stirred. By this, a precursor solution may be prepared. The aromatic compound and the solvent used in the present step may be in the same contents as those described in “A. Electrolyte solution-containing liquid composition, 1. Liquid composition” above; thus, the description herein is omitted.

2. Liquid Composition Preparing Step

The liquid composition preparing step in the present disclosure is a step of preparing a liquid composition by dissolving a metal into the precursor solution.

The dissolving a metal may be continuously performed in the environment with a low dew point. The dissolving a metal may be performed, for example, in an environment at room temperature. In order to facilitate the dissolution of the metal, warming may be performed, for example. The metal is a precursor of the metal cation. In order to facilitate the dissolution of the metal, the metal may be machined into a shape with a large surface area, for example.

The metal is introduced into the precursor solution. The molar ratio of the metal to the aromatic compound may be “metal/aromatic compound=1/1”, for example. For achieving substantially complete dissolution of the metal, the mixture is sufficiently stirred.

When the aromatic compound is a polyacene, the reaction of the following formula (3), for example, may proceed to produce a first ionic compound.

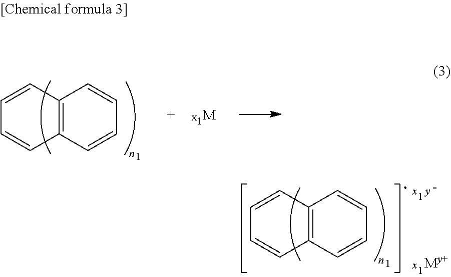

When the aromatic compound is a polyphenyl, the reaction of the following formula (4), for example, may proceed to produce a second ionic compound.

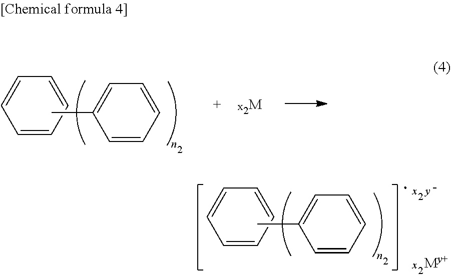

In the above-described manner, the liquid composition in the present disclosure is produced. After the liquid composition is produced, the liquid composition may be diluted or concentrated in such a way that the dissolved substance has a predetermined concentration. For example, the liquid composition may be diluted or concentrated in such a way that the dissolved substance has a concentration from 0.05 mol/L to 1.1 mol/L. The metal used in the present step may be in the same contents as those described in “A. Electrolyte solution-containing liquid composition, 1. Liquid composition” above; thus, the description herein is omitted.

3. Electrolyte Solution-Containing Liquid Composition Preparing Step

The electrolyte solution-containing liquid composition preparing step in the present disclosure is a step of preparing an electrolyte solution-containing liquid composition by mixing the liquid composition and an electrolyte solution so as a content of the electrolyte solution in the electrolyte solution-containing liquid composition is 30% by volume or more and 50% by volume or less.

The mixing of the electrolyte solution to the liquid composition may be performed by stirring using a rotator such as a stirrer, after introducing a predetermined amount of the electrolyte solution into liquid composition. Incidentally, the electrolyte solution and the mixed amount of the electrolyte solution used in the present step may be in the same contents as those described in “A. Electrolyte solution-containing liquid composition, 2. Electrolyte solution” above; thus, the description herein is omitted.

C. Method of Restoring Capacity of a Non-Aqueous Electrolyte Secondary Battery

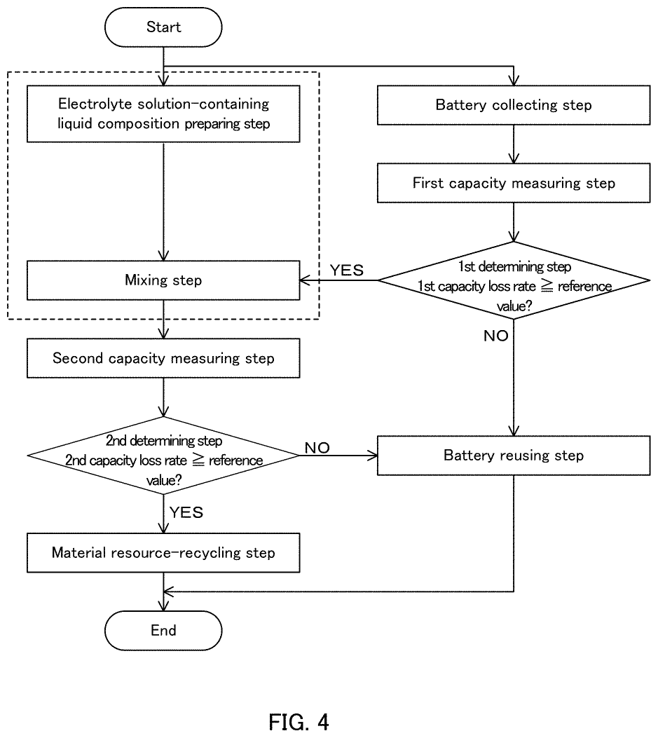

FIG. 4 is a schematic flowchart of a method of restoring capacity of a non-aqueous electrolyte secondary battery in the present disclosure. The method of restoring capacity of a non-aqueous electrolyte secondary battery in the present disclosure comprises: an electrolyte solution-containing liquid composition preparing step of preparing the electrolyte solution-containing liquid composition described above; and a mixing step of mixing the electrolyte solution-containing liquid composition with an electrolyte solution of the non-aqueous electrolyte secondary battery having an observed battery capacity loss from a predetermined capacity.

According to the present disclosure, by using the electrolyte solution-containing liquid composition described above, carrier ions, which contribute to charge and discharge, may be conveniently fed to a non-aqueous electrolyte secondary battery, so that the capacity of the non-aqueous electrolyte secondary battery may be restored. In the present disclosure, in addition to the electrolyte solution-containing liquid composition preparing step and the mixing step, another step may further be included according to the needs. Each step will be hereinafter described.

1. Electrolyte Solution-Containing Liquid Composition Preparing Step

The electrolyte solution-containing liquid composition preparing step in the present disclosure is a step of preparing the electrolyte solution-containing liquid composition described above. The electrolyte solution-containing liquid composition used in the present step may be in the same contents as those described in “A. Electrolyte solution-containing liquid composition”, and the method of preparing an electrolyte solution-containing liquid composition may be in the same contents as those described in “B. Method of producing electrolyte solution-containing liquid composition” above; thus, the description herein is omitted.

2. Mixing Step

The mixing step in the present disclosure is a step of mixing the electrolyte solution-containing liquid composition with an electrolyte solution of the non-aqueous electrolyte secondary battery having an observed battery capacity loss from a predetermined capacity.

For example, by a predetermined means, a casing of the battery is opened. When the casing has a liquid inlet, the liquid inlet is opened. Through the liquid inlet, the electrolyte solution-containing liquid composition is injected into the battery. Thereby, the electrolyte solution-containing liquid composition and the electrolyte solution of the battery may be mixed in the battery. For facilitating the incorporation, the battery may be gently shaken, for example. Also, after introducing, the mixture may be stirred using a rotator such as a stirrer. Further, in order to inhibit the gelatinization after introducing, a stepwise mixing wherein the electrolyte solution-containing liquid composition is introduced into the battery by multiple actions, may be performed.

The amount of the electrolyte solution-containing liquid composition used may be selected in accordance with, for example, the concentration of the electrolyte solution-containing liquid composition and the amount of carrier ions to feed. The amount of carrier ions to feed may be calculated from, for example, results of “3. Other steps, (3) First capacity measuring step” described below. For example, the amount of capacity loss (as quantity of electricity) may be converted into the number of moles of carrier ions and thereby the amount of carrier ions to feed may be calculated. The amount of the electrolyte solution-containing liquid composition used may be selected to be proper in relation to the amount of carrier ions to feed. When the amount of the electrolyte solution-containing liquid composition used is too high, for example, it is improper. When the amount is too high, an excessive amount of carrier ions may be supplied to a cathode to deteriorate a cathode active material.

After the electrolyte solution-containing liquid composition is mixed with the electrolyte solution of the battery, the battery is left to stand. By this, the metal cations in the electrolyte solution-containing liquid composition may be supplied to the cathode. In other words, carrier ions that contribute to charge and discharge may be fed. For example, the battery may be left to stand in an environment at a temperature from 0° C. to 80° C. For example, the battery may be left to stand in an environment at room temperature. The duration for leaving may be from 1 hour to 48 hours, for example. The duration for leaving may be from 6 hours to 24 hours, for example.

It is considered that the driving force for the reaction in the present disclosure is the difference between the electric potential of the electrolyte solution of the battery containing the electrolyte solution-containing liquid composition mixed therein and the electric potential of the cathode. Therefore, the higher the SOC of the battery is, the more facilitated the movement of the metal cations may be, for example. It may be because, the higher the SOC is, the higher the electric potential of the cathode is, and the larger the potential difference between the electrolyte solution and the cathode is. However, when the SOC is too high, the material inside the battery may tend to deteriorate while the battery is opened. At the time of mixing the electrolyte solution-containing liquid composition, the SOC of the battery may be from 10% to 100%, for example. At the time of mixing the electrolyte solution-containing liquid composition, the SOC of the battery may be from 30% to 80%, for example. At the time of mixing the electrolyte solution-containing liquid composition, the SOC of the battery may be from 40% to 60%, for example.

3. Other Steps

(1) Constant Current-Constant Voltage Charging Step

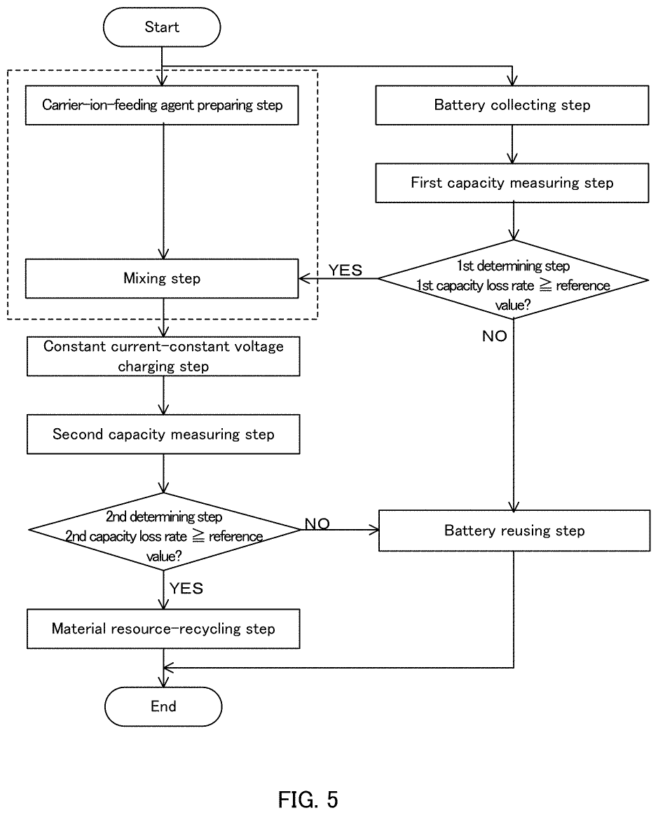

As described above, by the electrolyte solution-containing liquid composition being mixed into the electrolyte solution of a battery, the capacity of the battery is expected to be restored. Depending on the type of the composition introduced into a battery, the capacity of the battery is restored by mixing thereof into the battery. However, the battery capacity may be decreased in some cases, due to charge/discharge cycle in use thereafter. In such a case, improvement of the cycle property, for example, may be expected in some cases, by further performing constant current-constant voltage (CCCV) charging, where constant-current charging and constant-voltage charging are performed alternately, of the battery after mixing the composition, as illustrated in FIG. 5. FIG. 5 is a schematic flowchart of a method of restoring capacity of a non-aqueous electrolyte secondary battery when a conventional carrier-ion-feeding agent is used, and is the same as FIG. 4 illustrating a schematic flowchart of a method of restoring capacity of a non-aqueous electrolyte secondary battery in the present disclosure, with the addition of “constant current-constant voltage charging step”.

However, as apparent from Examples described below, for example, by using the electrolyte solution-containing liquid composition described above, a battery with good cycle property may be obtained, even though the constant current-constant voltage charging is not performed after mixing the electrolyte solution-containing liquid composition. Therefore, in the present disclosure, it is preferable that the method does not include a constant current-constant voltage charging step of performing constant current-constant voltage charging to the non-aqueous electrolyte secondary battery, after the electrolyte solution-containing liquid composition is mixed with the electrolyte solution of the non-aqueous electrolyte secondary battery. Thereby, the time required for restoring the battery capacity may be greatly decreased.

(2) Battery Collecting Step

The method of restoring capacity of a battery in the present disclosure may include collecting a battery. The battery may be collected by any method. For example, a used battery may be collected from the market. For example, a used battery may be collected during inspection, for example, a vehicle having a battery mounted thereon.

(3) First Capacity Measuring Step

The method of restoring capacity of a battery in the present disclosure may include measuring the capacity of the battery thus collected to calculate a first capacity loss rate. The capacity measurement may be performed with a typical charge-discharge apparatus. The first capacity loss rate (unit: %) may be calculated by the mathematical expression below. In the mathematical expression, Co denotes the initial capacity and Ci denotes the capacity measured after collection. For example, the rated capacity of the battery may be regarded as the initial capacity.

$$First capacity loss rate = \{ ( {C}_{0} - {C}_{1} ) / {C}_{0} \} \times 100$$

(4) First Determining Step

The method of restoring capacity of a battery in the present disclosure may include determining whether capacity restoration is required, based on the first capacity loss rate. For example, when the first capacity loss rate is a reference value or more, the process may proceed to “2. Mixing step” above. In other words, the electrolyte solution-containing liquid composition may be mixed with the electrolyte solution of the battery having an observed battery capacity loss from a predetermined capacity. The reference value may be selected optionally in accordance with the applications of the battery, the environment of use of the battery, for example. Incidentally, instead of the capacity, other properties may be determined. For example, resistance measurement, for example, may be performed. From results of the resistance measurement, whether capacity restoration is required may be determined. From results of the capacity measurement and the resistance measurement, whether capacity restoration is required may be determined.

(5) Battery Reusing Step

In “(4) First determining step” above, when the first capacity loss rate is lower than the reference value, for example, the battery may be reused as it is. The battery may be reused in the same application as the application at the time of collection. The battery may be reused in an application that is different from the application at the time of collection.

(6) Second Capacity Measuring Step

The method of restoring capacity of a battery in the present disclosure may include, after the electrolyte solution-containing liquid composition is mixed, measuring the capacity to calculate a second capacity loss rate. The second capacity loss rate may be calculated in the same manner as in the calculation of the first capacity loss rate.

(7) Second Determining Step

The method of restoring capacity of a battery in the present disclosure may include determining, based on the second capacity loss rate, whether resource-recycling of the material is required. For example, when the second capacity loss rate is a reference value or more, the process may proceed to “(8) Material resource-recycling step” below. For example, when the second capacity loss rate is lower than the reference value, the process may proceed to “(5) Battery reusing step” above; in other words, it may be considered that the capacity is sufficiently restored for reusing the battery.

(8) Material Resource-Recycling Step

In “(7) Second determining step” above, when the second capacity loss rate is a reference value or more, for example, it may be regarded as reusing the battery is difficult. The battery may be disassembled for collection of various materials (for example, rare metals).

4. Method of Restoring Capacity of a Non-Aqueous Electrolyte Secondary Battery

In the present disclosure, a lithium-ion battery is described as an example of the battery to be an object of the capacity restoring. However, the battery should not be limited to a lithium-ion battery as long as it includes a non-aqueous electrolyte solution. The battery may be a sodium-ion battery and a magnesium-ion battery, for example. Also, the structure of the battery may be similar to that of a typical battery; examples thereof may include a battery including a cathode, an anode, and an electrolyte solution, and a separator is interposed between the cathode and the anode.

In the present disclosure, the battery used as an object of the capacity restoring may be a used battery, for example. The battery used as an object may be an unused battery, for example. It is likely that the capacity of an unused battery is not substantially decreased. Typically, however, a film is formed on the anode during battery production. As a result, the amount of carrier ions in an unused battery may also be decreased from the initial amount. By mixing the electrolyte solution-containing liquid composition described above with an electrolyte solution of an unused battery, a battery with an increased capacity may be obtained. Such a battery with an increased capacity may have a capacity retention greater than 100%, for example. Meanwhile, when the battery is used, and the capacity is decreased, the capacity may be restored by mixing the electrolyte solution-containing liquid composition with the electrolyte solution of the battery.

D. Method of Producing Non-Aqueous Electrolyte Secondary Battery

The present disclosure may also provide a method of producing a non-aqueous electrolyte secondary battery comprising a capacity restoring step of performing the method of restoring capacity of a non-aqueous electrolyte secondary battery described above to a battery whose capacity is decreased. The method of restoring capacity of a non-aqueous electrolyte secondary battery may be in the same contents as those described in “C. Method of restoring capacity of a non-aqueous electrolyte secondary battery” above; thus, the description herein is omitted.

Incidentally, the present disclosure is not limited to the embodiments. The embodiments are exemplification, and any other variations are intended to be included in the technical scope of the present disclosure if they have substantially the same constitution as the technical idea described in the claim of the present disclosure and offer similar operation and effect thereto.

### EXAMPLES

### Example 1

<Preparation of Electrolyte Solution-Containing Liquid Composition>

Naphthalene powder was prepared as an aromatic compound, 1,2-dimethoxyethane (DME) was prepared as a solvent, and Li was prepared as a metal cation source. The materials were placed in a glove box. The glove box had an Ar atmosphere inside. The glove box had an environment with a low dew point, inside. Naphthalene was introduced to DME to prepare a first mixture. The first mixture was stirred to dissolve the whole amount of naphthalene in DME. Thus, a precursor solution was prepared. The amount of naphthalene introduced was adjusted so that its concentration in a liquid composition was to be 1.0 mol/L.

Li was introduced to the precursor solution to prepare a second mixture. The second mixture was stirred to dissolve the whole amount of Li. Thus, a liquid composition was prepared. The amount of Li introduced was adjusted so that its concentration in the liquid composition was to be 1.0 mol/L. It is considered that, in the solution, the reaction of the following formula (5) occurred to produce lithium naphthalenide.

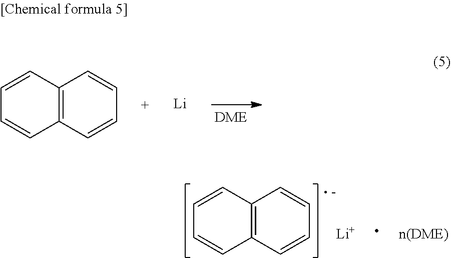

The obtained liquid composition and an electrolyte solution was mixed so that the content of the electrolyte solution in the electrolyte solution-containing liquid composition was to be 50% by volume. Thus, an electrolyte solution-containing liquid composition was prepared. For the mixed electrolyte solution, an electrolyte solution having the same composition as the electrolyte solution of the battery wherein the electrolyte solution-containing liquid composition is to be mixed to restore the capacity in the following step (an object of capacity restoring), was used. It is considered that the lithium naphthalenide concentration was 1.0 mol/L.

<Capacity Measurement of Used Battery>

In accordance with the procedure described below, the capacity of used lithium ion battery was measured. Two plate-shaped materials were prepared. The battery was interposed between these two plate-shaped materials. These two plate-shaped materials were fastened to each other so that a predetermined amount of load was applied to the battery. In this state, the battery was stored in a thermostatic chamber for three hours. The temperature inside the thermostatic chamber was set at room temperature.

After three hours of storage, the battery was connected to a charge-discharge apparatus. At a current rate of 0.5 C, a single charge-discharge cycle was performed from 0% SOC to 100% SOC. The discharged capacity at this time was defined as “a pre-introduction capacity”. The pre-introduction capacity was divided by the initial capacity to calculate “a pre-introduction capacity retention”. Results are shown in Table 1 below. The pre-introduction capacity retention of the used battery was approximately 50%. In other words, the capacity of the used battery had a decrease of approximately 50%.

<Mixing into Battery>

The SOC of the battery was adjusted to 50%. The electrolyte solution-containing liquid composition was introduced into the used battery. Inside the battery, the electrolyte solution-containing liquid composition was mixed with an electrolyte solution of the battery. As the electrolyte solution of the battery, a non-aqueous electrolyte solution wherein 1.1 M of LiPF₆ was dissolved into a non-aqueous solvent prepared by mixing ethylene carbonate (EC), dimethyl carbonate (DMC), and ethyl methyl carbonate (EMC) at volume ratio of 3:4:3, was used.

### Example 2

An electrolyte solution-containing liquid composition was prepared and was mixed into a used battery in the same manner as in Example 1 except that the liquid composition and the electrolyte solution were mixed so as the content of the electrolyte solution in the electrolyte solution-containing liquid composition is 30% by volume.

### Comparative Example 1

An electrolyte solution-containing liquid composition was prepared and was mixed into a used battery in the same manner as in Example 1 except that the tetrahydrofuran (THF) was used as the solvent instead of DME. In the present Comparative Example, constant current-constant voltage charging was performed for one week to the obtained battery, after mixing the electrolyte solution-containing liquid composition.

### Comparative Example 2

An electrolyte solution-containing liquid composition was prepared and was mixed into a used battery in the same manner as in Example 1 except that the tetrahydrofuran (THF) was used as the solvent instead of DME.

### Comparative Example 3

An electrolyte solution-containing liquid composition was prepared and was mixed into a used battery in the same manner as in Example 1 except that the liquid composition and the electrolyte solution were mixed so as the content of the electrolyte solution in the electrolyte solution-containing liquid composition is 0% by volume.

### Comparative Example 4

An electrolyte solution-containing liquid composition was prepared and was mixed into a used battery in the same manner as in Example 1 except that the liquid composition and the electrolyte solution were mixed so as the content of the electrolyte solution in the electrolyte solution-containing liquid composition is 20% by volume.

[Evaluation]

<Capacity Measurement of Battery after Introduction>

After the electrolyte solution-containing liquid composition was introduced, the battery was left to stand for 12 hours. After 12 hours, discharged capacity was measured in the same manner as described above. The discharged capacity at this time was defined as “a post-introduction capacity”. The post-introduction capacity was divided by the initial capacity to calculate “a post-introduction capacity retention”. The post-introduction capacity retention was divided by the pre-introduction capacity retention to calculate “a ratio of before and after introduction capacity retentions”. The results are shown in Table 1 below. A ratio of before and after the introduction capacity retentions greater than 1 means that the capacity was increased by the introduction.

<Cycle Resistance Test>

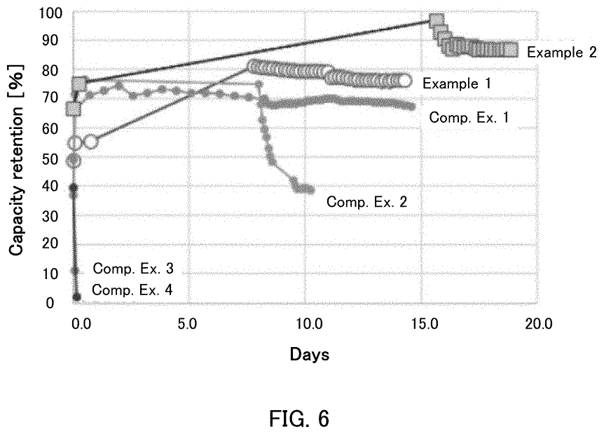

A cycle resistance test was performed to the battery after leaving to stand. The test was performed by charging and discharging for 100 cycles under the conditions of temperature of 25° C., constant current charging at 0.5 C, and constant current discharging at 0.5 C, from SOC 0% to SOC 100%. The results are shown in FIG. 6. After the cycle resistance test, the capacity of the battery was measured. Thus, “a post-cycle capacity retention” was calculated. The “post-cycle capacity retention” is shown in Table 1 below.

TABLE 1

| | Composition | | | | |
|---|---|---|---|---|---|
| | of electrolyte | | | | |
| | solution- | | Evaluations | | |
| | containing liquid | | Pre- | Capacity | |
| | composition | | introduction | retention | Ratio of |
| | | Electrolyte | capacity | after cycle | capacity |
| | | solution | retention | resistance test | retention |
| | | content | (A) | (B) | (B/A) |
| | Solvent | ratio | [%] | [%] | [—] |
| Example 1 | DME | 50% | 48.9 | 76.3 | 1.56 |
| Example 2 | DME | 30% | 66.5 | 86.7 | 1.30 |
| Comp. Ex. 1 | THF | 50% | 36.9 | 69.3 | 1.88 |
| Comp. Ex. 2 | THF | 50% | 39.0 | 38.6 | 0.99 |
| Comp. Ex. 3 | DME | 0% | 49.2 | 11.1 | 0.23 |
| Comp. Ex. 4 | DME | 20% | 39.6 | 2.1 | 0.05 |

In Examples 1 and 2 using DME as the solvent and including a predetermined amount of the electrolyte solution, the capacity was increased by mixing the electrolyte solution-containing liquid composition with the electrolyte solution of the battery. It is believed that this result was due to Li ion of the lithium naphthalenide was intercalated electrochemically only into the cathode. Meanwhile, in Comparative Examples 3 and 4 using DME as the solvent while including a little amount of the electrolyte solution, the capacity of the battery was drastically decreased after introducing the electrolyte solution-containing liquid composition. It is presumed that the content ratio of the electrolyte solution in the electrolyte solution-containing liquid composition influenced greatly to the restoration of the battery capacity.

Further, the capacity was increased by mixing the electrolyte solution-containing liquid composition with the electrolyte solution of the battery, also in Comparative Examples 1 and 2 using THF as the solvent. Although the cycle resistance was high in Comparative Example 1 wherein a constant current-constant voltage charging was performed after mixing, the capacity was rapidly decreased after the elapse of a certain period in Comparative Example 2 wherein the charging was not performed. In contrast, although a constant current-constant voltage charging after mixing was not performed in Examples 1 and 2 using DME as the solvent and including a predetermined amount of the electrolyte solution, it was confirmed that a high cycle resistance was exhibited in Examples 1 and 2, as similar to Comparative Example 1.

What is claimed is:

1. An electrolyte solution-containing liquid composition for use to feed carrier ions to a non-aqueous electrolyte secondary battery,
the electrolyte solution-containing liquid composition comprises a liquid composition including a solvent and a dissolved substance; and an electrolyte solution,
a content of the electrolyte solution in the electrolyte solution-containing liquid composition is 30% by volume or more and 50% by volume or less,
the solvent includes 1,2-dimethoxyethane,
the dissolved substance includes an ionic compound,
the ionic compound is composed of a radical anion of an aromatic compound and a metal cation,
the aromatic compound is polyacene or polyphenyl, and
the metal cation being an ion of the same type as the carrier ions.

2. The electrolyte solution-containing liquid composition according to claim 1, wherein
the radical anion includes at least one type selected from the group consisting of a naphthalene radical anion and a biphenyl radical anion, and
the metal cation includes lithium ions.

3. A method of producing an electrolyte solution-containing liquid composition for use to feed carrier ions to a non-aqueous electrolyte secondary battery, the method comprises:
a precursor solution preparing step of preparing a precursor solution by dissolving an aromatic compound into a solvent;
a liquid composition preparing step of preparing a liquid composition by dissolving a metal into the precursor solution; and
an electrolyte solution-containing liquid composition preparing step of preparing an electrolyte solution-containing liquid composition by mixing the liquid composition and an electrolyte solution so as a content of the electrolyte solution in the electrolyte solution-containing liquid composition is 30% by volume or more and 50% by volume or less, and
the solvent includes 1,2-dimethoxyethane,
the aromatic compound is polyacene or polyphenyl, and
a metal cation resulting from the metal being an ion of the same type as the carrier ions.

4. A method of restoring capacity of a non-aqueous electrolyte secondary battery, the method comprises:
an electrolyte solution-containing liquid composition preparing step of preparing the electrolyte solution-containing liquid composition according to claim 1; and
a mixing step of mixing the electrolyte solution-containing liquid composition with an electrolyte solution of the non-aqueous electrolyte secondary battery having an observed battery capacity loss from a predetermined capacity.

5. The method of restoring capacity of a non-aqueous electrolyte secondary battery according to claim 4, wherein the method does not include a constant current-constant voltage charging step of performing constant current-constant voltage charging to the non-aqueous electrolyte secondary battery, after the electrolyte solution-containing liquid composition is mixed with the electrolyte solution of the non-aqueous electrolyte secondary battery.
